(19) United States
(12) Patent Application Publication
(10) Pub. No.: US 2026/0146392 A1
(43) Pub. Date: May 28, 2026

(54) ROAD CONSTRUCTION MACHINE AND METHOD FOR SPRAYING EXTRACTED BITUMINOUS VAPORS WITH AN ATOMIZED LIQUID

(71) Applicant: JOSEPH VÖGELE AG, Ludwigshafen/Rhein (DE)

(72) Inventor: Klaus OETTINGER, Altlußheim (DE)

(73) Assignee: JOSEPH VÖGELE AG, Ludwigshafen/Rhein (DE)

(21) Appl. No.: 19/393,936

(22) Filed: Nov. 19, 2025

(30) Foreign Application Priority Data
Nov. 22, 2024 (EP) 24214838.5

(51) Int. Cl. E01C 19/48; B08B 15/00

(52) U.S. Cl. CPC E01C 19/48; B08B 15/00; E01C 2301/04

(57) ABSTRACT

The disclosure relates to a road construction machine configured in the form of a road paver or in the form of a feeder vehicle for supplying a road paver with paving material, wherein the road construction machine has at least one ventilation system with a suction side for generating negative pressure for extracting bituminous vapors and with a discharge side for generating positive pressure for blowing out the extracted bituminous vapors. The road construction machine further includes at least one spraying device provided on the discharge side for spraying an exhaust air flow formed there from extracted bituminous vapors with an atomized liquid.

### CROSS-REFERENCE TO RELATED APPLICATIONS

This application claims foreign priority benefits under 35 U.S.C. § 119(a)-(d) to European patent application number 24214838.5, filed November 22, 2024, which is incorporated by reference in its entirety.

### TECHNICAL FIELD

The present disclosure relates to a road construction machine and to a method for operating a road construction machine.

### BACKGROUND

EP3276081A1 discloses a road construction machine configured as a road paver with a paving screed. This road paver has a spraying device positioned in front of the paving screed to spray the bituminous vapors generated in the area of a transverse distribution above a transverse distribution screw with an atomized liquid, in particular water, so that the bituminous aerosols contained in the vapors are bound by the spray mist and thus cannot rise up to an operator on the driver's operating station. An extraction device, as disclosed in US 5,938,371, can additionally be used on this road paver to extract bituminous vapors, in particular vapors mixed with spray mist, from the transverse distribution area.

However, the problem with a road paver in which bituminous vapors generated in the transverse distribution area are both sprayed and extracted is that the sprayed bituminous vapors become more difficult to extract with increasing humidity due to the extraction device, which means that the spraying device can impair the operation of the extraction device. In addition, the extraction of sprayed vapors can lead to increased condensate formation within the extraction device, which can further reduce the extraction capacity and may cause the extraction device to wear out more quickly.

### SUMMARY

It is an object of the disclosure to provide a road construction machine in the form of a road paver or a feeder vehicle, as well as a method, by means of which bituminous vapors can be kept away from the operating personnel more effectively in order to improve the working conditions for the operating personnel.

This object is achieved by a road construction machine according to the disclosure and by a method according to the disclosure.

The road construction machine according to the disclosure is configured in the form of a road paver or in the form of a feeder vehicle for supplying a road paver with paving material. The road construction machine according to the disclosure comprises at least one ventilation system with a suction side that generates negative pressure for extracting bituminous vapors and with a discharge side that generates positive pressure for blowing out the extracted bituminous vapors. Furthermore, the road construction machine according to the disclosure has at least one spraying device that is provided on the discharge side generating positive pressure for spraying an exhaust air flow formed there from extracted bituminous vapors with an atomized liquid.

In contrast to the cited prior art, in which a spraying device sprays vapors on the suction side that generates the negative pressure, according to the disclosure, the spraying of bituminous vapors takes place on the discharge side of the ventilation system. This allows the ventilation system to be operated more energy-efficiently and makes it easier to extract the bituminous vapors. Above all, embodiments according to the disclosure make it possible to better prevent condensation from forming within the ventilation system, or at least to reduce it to such an extent that gentle operation of the ventilation system is ensured. This is due to the fact that, according to the disclosure, by spraying the exhaust air flow generated on the discharge side by overpressure, the bituminous vapors extracted are first cooled by the spray mist at the outlet of the ventilation system and then sink to the floor in a more coordinated manner due to their associated increase in weight.

According to an embodiment of the disclosure, it is provided that the exhaust air flow within and/or outside a pipe end section of an exhaust air pipe provided on the discharge side of the ventilation system can be sprayed. In other words, in this variant, the extracted bituminous vapors are cooled and weighted only at the end or at the outlet of the exhaust air pipe in order to bind the aerosols contained in the extracted bituminous vapors in a targeted manner by means of an atomized liquid sprayed in, for example by means of an atomized spray mist of water, so that they can no longer float unhindered to the operating personnel of the road construction machine.

According to a variant of the disclosure, the spraying device comprises at least one nozzle which is configured to spray the exhaust air flow within the pipe end section. This nozzle can in particular be structurally integrated in the pipe end section. This means that the pipe end section itself forms the nozzle, that is, it fulfills a dual function by forming both the exhaust air pipe in sections and the nozzle of the spraying device.

Preferably, the spraying device has at least one nozzle which is configured to spray the exhaust air flow outside the pipe end section. This nozzle can, for example, be assigned to an outlet opening of the pipe end section in order to spray the exhaust air flow outflowing from the outlet opening immediately after leaving the pipe end section. It would be possible for the nozzle to be attached directly to the outlet of the pipe end section in order to atomize the outflowing exhaust air stream. In this variant, too, the nozzle can be an integral part of the pipe end section. Alternatively, the nozzle can be configured separately from the pipe end section in order to spray the out-flowing exhaust air flow outside the pipe end section, at a certain distance from the outlet opening, for example with water.

Preferably, the pipe end section has at least one connection for the spraying device, in particular for a hose of the spraying device, which supplies the at least one nozzle provided in the region of the pipe end section with liquid, in particular with water.

According to a preferred embodiment of the disclosure, the pipe end section is detachably fastened, in particular removable without tools. This allows the pipe end section to be easily removed, in particular for cleaning purposes. It would be conceivable for the pipe end section to be detachably fastened to the exhaust air pipe without tools by means of a screw connection and/or a toggle lever lock.

Preferably, a spray pattern of the atomized liquid sprayed outside the pipe end section is set in such a way that the exhaust air flow emerging from the pipe end section can be deflected in a desired direction, in particular in the direction of a ground surface on which the road construction machine is moving. In this variant, the liquid injected, for example in the form of an inclined lamella, can exert a carrying or guiding effect on the exhaust air flow outflowing from the pipe end section in order to continue to convey the exhaust air flow in a targeted manner, in particular in the direction of the ground surface, so that the aerosols contained therein can be deposited reliably and even more quickly in the direction of the ground.

Preferably, the exhaust air flow is sprayed by means of the spraying device within an engine compartment of the road construction machine, in particular in the area of a floor of the engine compartment. The exhaust air flow conducted there by means of the exhaust air pipe can be blown out at a short distance from the ground, for example at a maximum distance of one hundred centimeters above the ground on which the road construction machine is moving, and be misted with the atomized spray agent so that the aerosols contained in the exhaust air flow can no longer spread upward toward the driver's operating station.

According to one embodiment, the exhaust air flow can be sprayed by means of the spraying device behind a driver's operating station, at the level of a roof of the road construction machine. The exhaust air flow misted with spray fluid also sinks reliably to the ground due to its increased weight and can therefore be directed outside the driver's operating station during a paving run without reaching the area of the driver or the screed operator next to the machine.

It would be useful if the spray output of the spraying device could be controlled (e.g., by a control unit and associated sensor(s)), in particular dynamically, depending on a set suction capacity of the ventilation system and/or depending on a detected weather condition, in particular a detected wind speed and/or a detected air humidity. This allows the spraying device to be optimally adapted to the current operating mode of the ventilation system in order to reliably precipitate the aerosols contained in the extracted bituminous vapors and/or to react specifically to the current weather conditions in order to adapt to them. For example, the spray output could be reduced in high humidity, especially when it is raining on the construction site. On the other hand, the spray output could be increased in high wind speeds on the construction site so that the bituminous vapors extracted by the ventilation system cannot be blown into the operator's area after they are emitted due to increased weight gain.

According to one variant, the ventilation system is configured for extracting bituminous vapors above a transverse distribution screw, for extracting bituminous vapors from a material container of the road construction machine, extracting bituminous vapors along a conveyor belt, extracting bituminous vapors at a transfer area formed between conveyor belts conveying one behind the other, and/or extracting bituminous vapors at the outlet of a discharge belt, in particular at the outlet of a swivel belt.

It would be particularly conceivable for the ventilation system to be configured to extract bituminous vapors at different points on the road construction machine and to combine them along the exhaust air pipe in order to form the exhaust air flow, so that spraying with spray fluid at the outlet of the ventilation system is only possible at one point on the road construction machine.

In particular, the ventilation system comprises a radial fan, preferably a radial fan with adjustable speed. This can be installed in particular in the engine compartment of the road construction machine and supplied with power by a generator installed therein.

One embodiment provides that the ventilation system and/or the spraying device is at least partially configured as a modular retrofit kit. In particular, the ventilation system and/or the spraying device may comprise components that are both detachable and permanently installed on the road construction machine. It would be conceivable for externally visible sections of the ventilation system and/or the spraying device to be detachably fastened by means of connectors and for other components of the ventilation system and/or the spraying device, for example a fan and/or a pump, to be structurally integrated within the engine compartment.

The spraying device is preferably configured to collect condensate formed by spraying the exhaust air flow and to separate aerosols contained therein. For this purpose, the spraying device can be equipped with a collection container and a return line with a filter function. This would allow at least partial recirculation of the liquid used as the spraying agent.

According to an embodiment of the disclosure, the spraying device is configured for spraying bituminous vapors rising from a material container of the road construction machine and/or for spraying bituminous vapors rising from a material container of a road paver following the road construction machine, provided that no extraction takes place in these areas. The spraying device can have at least one drone and/or at least one atomizing nozzle assigned to these spraying areas for this purpose.

According to a preferred embodiment of the disclosure, the spraying device comprises a tank, in particular a temperature-controllable tank, and a pump, in particular an electrically operated pump or a pump connected to a pump distributor gear. It would be particularly conceivable for the tank to be actively cooled in order to maintain the liquid stored therein, for example water, at a temperature level such that a sufficient cooling effect is achieved when spraying the exhaust air flow in order to effectively precipitate the vapors contained in the exhaust air flow.

Preferably, a pump of the spraying device and a fan of the ventilation system can be connected by means of a coupling and/or by means of a gear and can be driven by a common drive, for example an electric motor, or are connected together to a pump distributor gear.

It would be helpful if a filler neck of the spraying device could be accessed by an operator from the ground by opening a side panel, in particular a side panel configured as a door, on the road construction machine.

Preferably, the ventilation system is configured to be heatable at least in sections. This prevents condensation from forming inside the ventilation system. One variant provides for the ventilation system to be installed inside the engine compartment of the road construction machine in such a way that it can be heated, at least in sections, in particular the exhaust air pipe formed thereon, at least in sections, by means of a heated cooling air flow, for example by means of a heated cooling air flow formed within the engine compartment to dissipate heat from an engine of the road construction machine, in order to counteract the formation of condensate within the ventilation system.

The disclosure also relates to a paving train comprising at least one road paver according to the disclosure and/or at least one feeder vehicle according to the disclosure for supplying the road paver with paving material.

It would be conceivable for the paving train to have two road pavers according to the disclosure traveling one behind the other in the paving direction, wherein the road paver traveling in front in the paving direction is configured as a binder paver in order to lay a binder layer, and the road paver following it in the paving train in the paving direction is configured as a surface paver in order to produce a surface layer on the binder layer. The surface paver can be supplied with paving material by the binder paver traveling ahead.

The disclosure further relates to a method for extracting bituminous vapors on a suction side generating negative pressure on a road paver and/or on a feeder vehicle for a road paver. The disclosure provides that, on a discharge side generating positive pressure, an exhaust air flow formed from the extracted bituminous vapors is sprayed with an atomized liquid, for example water. This results in advantageous, particularly energy-efficient and gentle operation of the ventilation system in order to reliably precipitate aerosols within the extracted vapors on the discharge side so that they can be kept away from the operating personnel.

### BRIEF DESCRIPTION OF THE DRAWINGS

Embodiments according to the disclosure are explained below in more detail with reference to the following Figures:

FIG. 1 shows a road construction machine in the form of a road paver with a spraying device for spraying an exhaust air flow,

FIG. 2 shows a road construction machine in the form of a road paver with a spraying device for spraying an exhaust air flow,

FIG. 3 shows a road construction machine in the form of a feeder vehicle with a spraying device for spraying an exhaust air flow,

FIG. 4 shows spraying an exhaust air flow outside a pipe end section of an exhaust air pipe, and

FIG. 5 shows spraying an exhaust air flow inside a pipe end section of an exhaust air pipe.

### DETAILED DESCRIPTION

Technical features are identified throughout the Figures using the same reference signs.

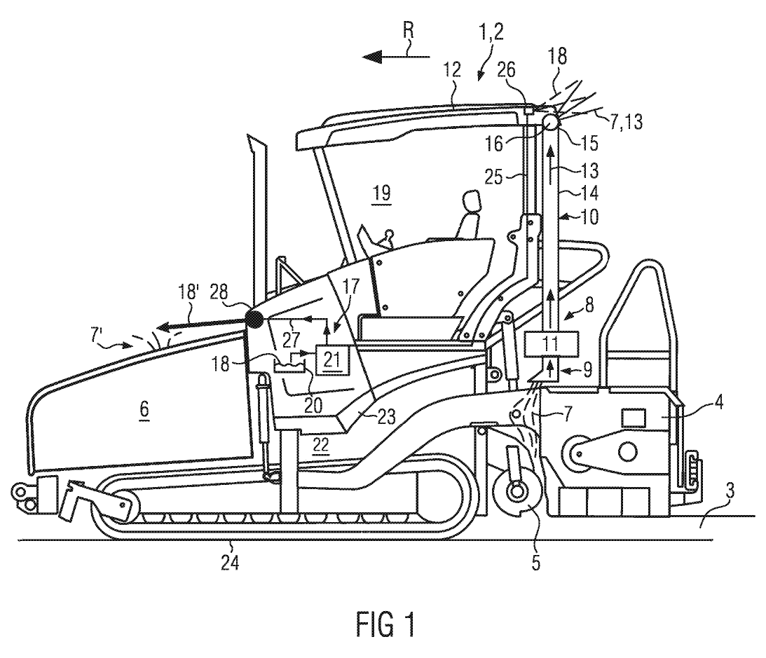

FIG. 1 shows a road construction machine 1 configured in the form of a road paver 2 for producing a new paving layer 3. The road paver 2 has a paving screed 4 by means of which the paving layer 3 can be produced. A transverse distribution screw 5 is positioned in front of the paving screed 4 in the direction of travel R. The transverse distribution screw 5 is supplied with paving material from a material container 6 by means of a not shown longitudinal conveying device, which spreads the transverse distribution screw 5 in front of the paving screed 4.

Bituminous vapors 7 are generated during the transverse distribution of the paving material in front of the paving screed 4. A ventilation system 8 is provided on the road paver 2 shown in FIG. 1 to extract the bituminous vapors 7 from the transverse distribution area. The ventilation system 8 is equipped with a suction side 9 that generates negative pressure to extract the bituminous vapors. The ventilation system 8 also has a discharge side 10 that generates positive pressure to blow out the extracted bituminous vapors 7. To extract the bituminous vapors 7, the ventilation system 8 comprises a fan 11, in particular a radial fan, between the suction side 9 and the discharge side 10.

FIG. 1 shows that the extracted bituminous vapors 7 are blown out by the ventilation system 8 at the level of a roof 12 of the road paver 2. For this purpose, an exhaust air flow 13 generated by the fan 11 is transported along an exhaust air pipe 14 to a pipe end section 15 positioned at the level of the roof 12, at the outlet opening 16 of which the exhaust air flow 13 is discharged.

FIG. 1 also shows that the road paver 2 has a spraying device 17. This is configured to spray the bituminous vapors 7 extracted from the transverse distribution area with an atomized liquid 18 on the pressure-generating discharge side 10 of the ventilation system 8 at the level of the roof 12 of the road paver 2 when the extracted vapors 7 leave the exhaust air pipe 14. This allows the bituminous aerosols emitted in the exhaust air flow 13 to be bound by the spray mist formed from the liquid 18, preventing them from spreading further to an operator at the driver's operating station 19. The spray mist causes droplets to form on the aerosols, so that they sink down behind the driver's operating station 19 due to their increase in weight.

FIG. 1 shows that the spraying device 17 has a tank 20 for storing the liquid 18 and a pump 21 connected to the tank 20. The tank 20 and the pump 21 are arranged in an engine compartment 22 of the road paver 2. According to FIG. 1, the tank 20 and the pump 21 are positioned behind a side panel 23 that can be opened within the engine compartment 22 so that they are accessible to an operator from the ground 24 on which the road paver 2 is moving, for example for filling the tank 20.

The pump 21 is connected via a pipe 25 to a nozzle 26 of the spraying device 17 positioned at the level of the roof 12, which is configured as an atomizing nozzle for producing the atomized liquid 18.

According to FIG. 1, a further pipe 27 leads from the pump 21 of the spraying device 17 to a further nozzle 28, which is configured to spray bituminous vapors 7' rising directly from the material container 6 with atomized liquid 18'.

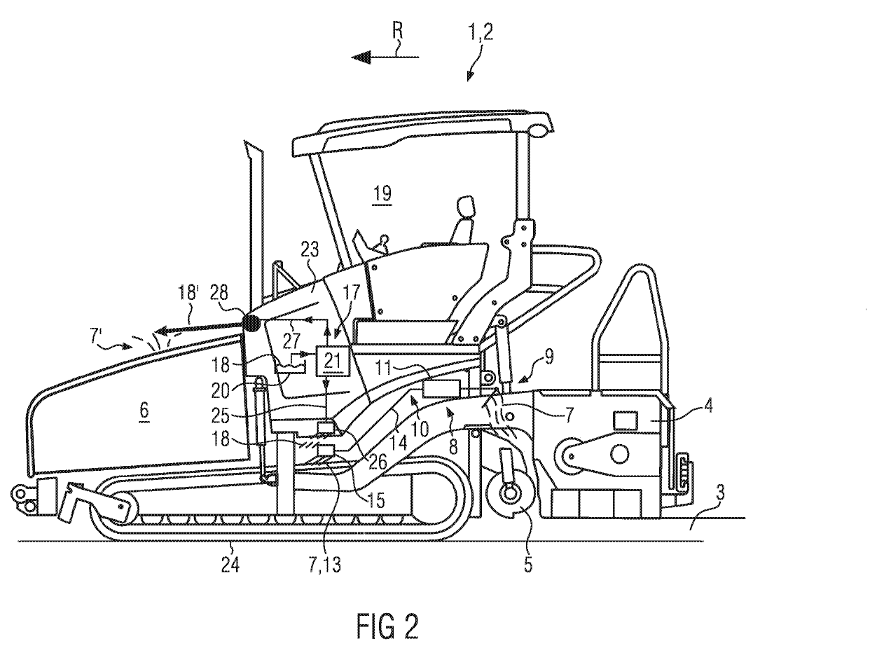

FIG. 2 shows a road paver 2 in which the ventilation system 8 installed thereon discharges the bituminous vapors 7 extracted from the transverse distribution area via the exhaust air pipe 14 laid on the pressure-generating discharge side 10 at a short distance above the ground 24. In this variant, the pipe end section 15 of the exhaust air pipe 14 is positioned within the engine compartment 22 in such a way that the exhaust air flow 13 outflowing from the pipe end section 15 can be sprayed by the atomized liquid 18 at a short distance above the ground 24, for example at a distance of less than 100 cm above the ground 24, by means of the atomized liquid 18.

In contrast to the embodiment shown in FIG. 1, the extracted vapors 7 are discharged and sprayed with the atomized liquid 18 at a short distance from the ground 24 within the engine compartment 22. This allows the bituminous aerosols contained in the exhaust air flow 13 to be reliably kept away from the operating personnel of the road paver 2, in particular from the driver at the operating station 19 and from the screed operator.

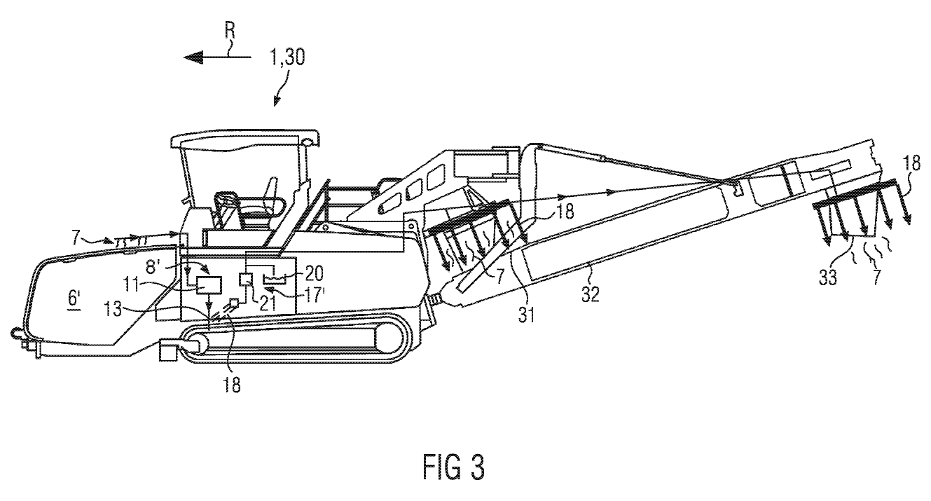

According to FIG. 3, the road construction machine 1 is configured as a feeder vehicle 30. On the feeder vehicle 30 according to FIG. 3, bituminous vapors 7 are extracted from a material container 6' by means of a ventilation system 8' of the feeder vehicle 30. The ventilation system 8' is configured to discharge the extracted bituminous vapors 7 at a short distance above the ground 24 on which the feeder vehicle 30 is moving. The discharged exhaust air flow 13 is sprayed with atomized liquid 18, which is formed by a spraying device 17' provided on the feeder vehicle 30.

Furthermore, FIG. 3 shows that the spraying device 17' of the feeder vehicle 30 is configured to spray bituminous vapors 7 with atomized liquid 18 at other locations of the feeder vehicle 30. FIG. 3 shows that in an area 31 at the entrance to a swivel belt 32, onto which installation material falls from a conveyor belt not shown, bituminous vapors 7 produced in this way are sprayed. Furthermore, FIG. 3 shows that bituminous vapors 7 rising at a drop point 33 can be sprayed with atomized liquid 18. The vapors 7 arising at the drop point 33 can, for example, rise from a material container 6 of a road paver 2 following the feeder vehicle 30, which is supplied with paving material by the feeder vehicle 30.

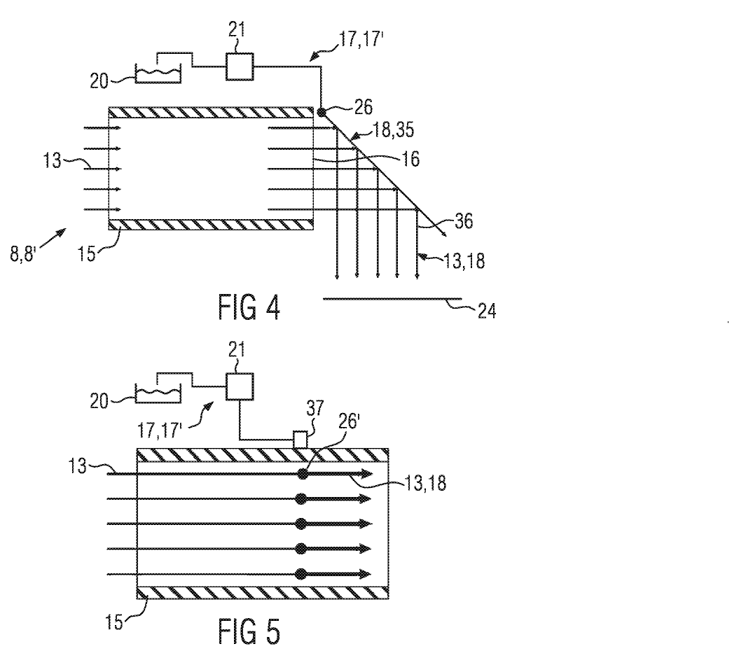

FIG. 4 shows an isolated view of the pipe end section 15 of the ventilation system 8, 8'. The exhaust air flow 13 flowing out of the outlet opening 16 is sprayed with the atomized liquid 18 outside the pipe end section 15, as shown in FIG. 4. For this purpose, according to FIG. 4, the nozzle 26 is positioned outside the pipe end section 15 and aligned with its outlet opening 16 in such a way that a spray pattern 35 produced by it directs the exhaust air flow 13 emerging from the pipe end section 15 in the direction 36 towards the ground 24.

FIG. 5 shows the pipe end section 15 of the ventilation system 8, 8' with a connection 37 for the spraying device 17, 17'. The nozzle 26' or nozzles 26' can be supplied with liquid 18 from the tank 20 via this connection 37. At the pipe end section 15 shown in FIG. 5, the atomized liquid 18 is injected into the exhaust air flow 13 formed therein within the pipe end section 15. Contrary to what is shown in FIG. 5, the pipe end section 15 can be mounted at an angle so that it forms a gradient, allowing the exhaust air flow 13 mixed with spray mist to flow out of the pipe end section 15 more easily.

As one skilled in the art would understand, the above-mentioned control unit, as well an any other controller, sensor(s), device, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such control unit, controller, sensor(s), device, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

What is claimed is:

1. A road construction machine configured as a road paver or a feeder vehicle for supplying a road paver with paving material, wherein the road construction machine comprises a ventilation system with a suction side for generating negative pressure for extracting bituminous vapors and with a discharge side for generating positive pressure for blowing out the extracted bituminous vapors, and a spraying device, wherein the spraying device is provided on the discharge side for spraying an exhaust air flow formed there from extracted bituminous vapors with an atomized liquid.

2. The road construction machine according to claim 1, wherein the ventilation system includes an exhaust air pipe having a pipe end section provided on the discharge side, and the spraying device is configured to spray the exhaust air flow inside and/or outside the pipe end section.

3. The road construction machine according to claim 2, wherein the spraying device comprises at least one nozzle which is configured to spray the exhaust air flow inside the pipe end section and/or has at least one nozzle which is configured to spray the exhaust air flow outside the pipe end section.

4. The road construction machine according to claim 2, wherein the pipe end section has at least one connection for the spraying device.

5. The road construction machine according to claim 2, wherein the pipe end section is detachably fastened to a portion of the exhaust air pipe.

6. The road construction machine according to claim 5, wherein the pipe end section is removable without tools from the portion of the exhaust air pipe.

7. The road construction machine according to claim 2, wherein the spraying device is configured to spray the atomized liquid outside the pipe end section with a spray pattern that is set in such a way that the exhaust air flow emerging from the pipe end section is deflectable in a desired direction.

8. The road construction machine according to claim 7, wherein the exhaust air flow emerging from the pipe end section is deflectable towards a ground on which the road construction machine is moving.

9. The road construction machine according to claim 1, wherein the spraying device is configured to spray the exhaust air flow within an engine compartment of the road construction machine.

10. The road construction machine according to claim 9, wherein the spraying device is configured to spray the exhaust air flow in an area of a floor of the engine compartment.

11. The road construction machine according to claim 1, wherein a spraying capacity of the spraying device is controllable as a function of a set suction capacity of the ventilation system and/or in dependence on a detected weather condition.

12. The road construction machine according to claim 11, wherein the spraying capacity of the spraying device is controllable in dependence on a detected wind speed and/or a detected air humidity.

13. The road construction machine according to claim 1, wherein the ventilation system and/or the spraying device is at least partially configured as a modular retrofit kit.

14. The road construction machine according to claim 1, wherein the spraying device is configured to collect condensate formed by spraying the exhaust air flow and to separate aerosols contained therein.

15. The road construction machine according to claim 1, wherein the spraying device is configured for spraying bituminous vapors rising from a material container of the road construction machine and/or for spraying bituminous vapors rising from a material container of a road paver following the road construction machine.

16. The road construction machine according to claim 1, wherein the spraying device comprises a tank and a pump.

17. The road construction machine according to claim 16, wherein the tank is temperature-controllable, and the pump comprises an electrically operated pump or a pump connected to a pump distribution gear.

18. The road construction machine according to claim 1, wherein the spraying device comprises a filler neck that is accessible to an operator from ground by opening a side panel on the road construction machine and/or the ventilation system is configured to be heated at least in sections.

19. A paving train comprising at least one road construction machine according to claim 1.

20. A method comprising:
generating negative pressure on a suction side of a ventilation system on a road paver and/or on a feeder vehicle for a road paver to extract bituminous vapors on the suction side;
generating positive pressure on a discharge side of the ventilation system to blow out the extracted bituminous vapor; and
spraying an exhaust air flow formed from the extracted bituminous vapors with an atomized liquid.
